(19) United States
(12) Patent Application Publication
(10) Pub. No.: US 2010/0192001 A1
(43) Pub. Date: Jul. 29, 2010

(54) DEVICE TIME ADJUSTMENT FOR ACCURATE DATA EXCHANGE

(75) Inventors: Mark Cornwall, Spokane, WA (US); Barry Cahill-O'Brien, Spokane, WA (US); Jack Tweedy, Spokane, WA (US)

Correspondence Address: DORITY & MANNING, P.A., POST OFFICE BOX 1449, GREENVILLE, SC, 29602-1449, US

(73) Assignee: ITRON, INC., Liberty Lake, WA (US)

(21) Appl. No.: 12/362,397

(22) Filed: Jan. 29, 2009

(51) Int. Cl. G06F 1/12

(52) U.S. Cl. 713/400

(57) ABSTRACT

The clock of an endpoint device is adjusted to a collection system time in a meter reading system where the endpoint device is employed to read and record meter reading data for calculation of consumption data. Specifically, the meter reading data are recorded as a fixed number of intervals in such a way that the calculation of consumption data can be requested by indication of the number of intervals and the start interval. In one aspect, the endpoint device time is adjusted to an external clock to calculate accurate consumption while the process for adjusting the endpoint device time does not result in creating very short/long intervals, nor updating the meter reading data that have been already logged and stored in the endpoint device.

### BACKGROUND

Through advancements in metering infrastructure, the collection of meter readings that quantify the consumption of utility services (i.e., natural gas, water, electricity, etc.) is being automated. In an automated meter reader system, “endpoint devices” coupled to utility meters are typically used to collect and record the meter readings for transmission to reader devices. The endpoint devices that are configured to communicate consumption data in this way are commercially available and increasingly being installed in homes, businesses, and the like.

In some automated meter reader systems, the endpoint devices are configured to record meter readings at predetermined intervals and to transmit the meter readings to a reader device. In some cases, the endpoint devices include a microprocessor-implemented real time clock that is used when recording meter reading data or transmitting meter reading data. In such cases, synchronization among various endpoint devices and reader devices is necessary within the automated meter reader system. However, such synchronization has been a challenge due to the time differences among time zones, daylight savings time adjustment, leap year adjustment, etc.

In other implementations, each endpoint device includes a simple timing device, which eliminates the need of real time synchronization among the endpoint devices. In these implementations, the reader device, which collects meter reading data from the endpoint devices, typically adds a timestamp to the collected meter reading data.

In an ideal environment, the time-stamped data are processed later in a processing system and thus the reader device does not need to perform much computation other than adding timestamps. However, if the endpoint device time has drifted, the reader device cannot simply timestamp the collected data. In most cases, the reader device and the endpoint device exchange several messages to determine the time drift and to generate accurate timestamps for the collected data. For some types of meter reading systems, in particular, for a meter reading system that includes a small number of reader devices that collect meter readings from a large number of endpoint devices, this can possibly lead to overburdening the reader devices.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method and system are provided for adjusting an endpoint device time to the time provided by a collection system in a meter reading system. In the meter reading system, endpoint devices are employed to read and record meter reading data for calculation of consumption data. In one embodiment, the meter reading data are recorded as a fixed number of intervals in such a way that the calculation of consumption data can be requested by indication of a particular set of intervals or the like. In one aspect, endpoint device time is adjusted to an external clock, for example a collection system clock, to calculate accurate consumption while the process for adjusting the endpoint device time does not result in creating very short/long intervals, nor updating the meter reading data that have been already logged and stored in the endpoint device. In this embodiment, the process for adjusting the endpoint device time is based on the endpoint delaying implementing the time adjustment to eliminate the possibility of small intervals or long intervals.

In accordance with an aspect of an embodiment, a method for adjusting time of a device is provided where the device is configured to collect meter reading data from a corresponding meter, and to transfer the collected meter reading data to a collection system. In one aspect, the meter reading data collected at each time interval is recorded and a recorded interval is generated. The time interval information and the generated record interval are stored in the device. The method comprises receiving a collection system time and determining a difference between the current collection system time and a device time of the device. If the difference is as great as the threshold, the device time adjustment is delayed until the difference becomes less than a threshold. If the difference is less than the threshold, the device time is adjusted to the current reader time and then, the endpoint device detects a triggering event for recording meter reading data. Upon detection, the endpoint device records meter reading data along with an indication of the adjustment of the device time after adjustment of the device time.

In accordance with another aspect of an embodiment, an apparatus is provided for transferring accurate meter reading data to a collection system. The apparatus is operable to receive, from the collection system, a current reader time and a request for meter reading data that are collected over a requested time period and determine a difference between the current reader time and a device time of the clock. If the difference is as great as the threshold, the device time adjustment is delayed until the difference becomes less than a threshold. If the difference is or becomes less than the threshold, the apparatus adjusts the clock to the current reader time. After adjusting the time, the apparatus implements recording of meter reading data based on the adjusted device time.

In accordance with yet another aspect of an embodiment, a computer-readable medium having computer-executable components for adjusting a device time to calculate accurate meter reading data is provided. The computer-executable components may comprise a recording component, a calculation component and an adjustment component. The recording component is configured to store a set of recorded intervals, wherein a recorded interval is generated to include the meter reading data collected at a particular time interval. In one aspect, a fixed number of the recorded intervals are maintained in the device. The calculation component is configured to calculate the consumption of a utility service over a specified number of time intervals. The adjustment component is operative to determine a difference between the current reader time and the device time of an endpoint device. If the difference is not less than the threshold, the adjustment component is operative to delay the device time adjustment until the difference becomes less than a threshold. If the difference is or becomes less than the threshold, the adjustment component adjusts the device time to the current reader time. Subsequently, the adjustment component detects a start of a time interval in accordance with the adjusted device time and upon detection, records meter reading data along with an indication of the adjustment of the device time.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an illustrative metering environment suitable for adjusting endpoint device time;

FIG. 2 is a block diagram illustrating components of one example of an endpoint device in accordance with an embodiment of the disclosed subject matter;

FIG. 3 is a flow diagram of one example routine for logging meter readings at each predetermined interval in accordance with an embodiment of the disclosed subject matter; and

FIG. 4 is a flow diagram of one example routine for adjusting time in an endpoint device in accordance with an embodiment of the disclosed subject matter.

### DETAILED DESCRIPTION

The detailed description set forth below in connection with the appended drawings is intended as a description of various embodiments of the disclosed subject matter and is not intended to represent the only embodiments. Generally stated, a timing device or clock of an endpoint device is adjusted based on a technique of managing and recording meter reading data. In one embodiment, the meter reading data are recorded in a fixed number of intervals so that the calculation of consumption data can be easily performed by the endpoint device. As will be described in more detail below, the endpoint device time may be adjusted to an external clock for calculating accurate consumption without resulting in the creation of excessively short/long intervals, or updating the meter reading data that have been already logged and stored in the endpoint device. In this regard, the process for adjusting the clock is based on the endpoint device delaying a time adjustment to eliminate the possibility of small intervals or long intervals.

Each embodiment described in this disclosure is provided merely as an example or illustration and should not be construed as preferred or advantageous over other embodiments. In this regard, the following description first provides an overview of a metering environment in which the disclosed subject matter may be implemented. Then, several examples of routines used for recording meter reading data at intervals and providing meter reading data with adjusted time are described. The illustrative examples provided herein are not intended to be exhaustive or to limit the invention to the precise forms disclosed. Similarly, any steps described herein may be interchangeable with other steps, or combinations of steps, in order to achieve the same or substantially similar result.

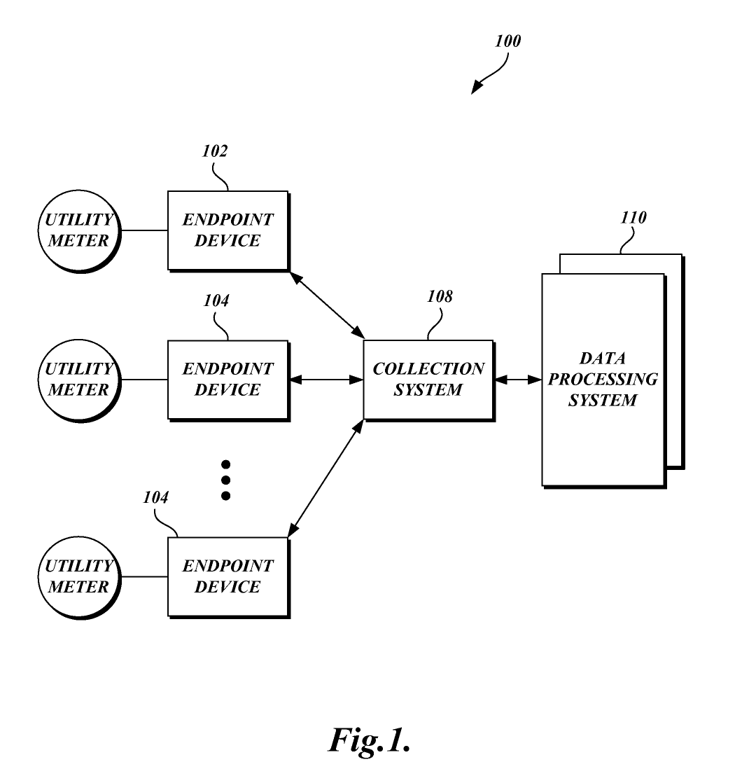

Referring now to FIG. 1, the following is intended to provide a general overview of one embodiment of a meter reading system 100 in which aspects of the disclosed subject matter may be implemented. Generally described, the meter reading system 100 depicted in FIG. 1 includes a plurality of endpoint devices 102-106 associated with, for example, utility meters (e.g., gas meters, water meters, electric meters, etc.), for obtaining data, such as meter data (e.g., consumption data, tampering data, etc.) therefrom. Each endpoint device 102 in the meter reading system 100 may be a wired or wireless communications device capable of performing two way communications with the collection system 108 utilizing automated meter reading protocols. For example, the endpoint devices 102 are capable of receiving data (e.g., messages, commands, etc.) from the collection system 108 and transmitting meter reading data and/or other data to the collection system 108. Depending on the exact configuration and types of devices used, the endpoint devices 102-106 transmit data either periodically (“bubble-up”), in response to a wake-up signal, in response to a request from the collection system, in a combination/hybrid configuration. In each instance, the endpoint devices 102-106 are configured to exchange data with the collection system 108.

In some embodiments, the collection system 108 may employ some type of a protocol to communicate with the endpoint devices 102-106. The collection system 108 is suitable to transmit a request to the endpoint devices for obtaining meter reading data and to receive messages including meter reading data from the endpoint devices. In this regard, the collection system 108 may be a fixed network comprised of Cell Control Units (“CCU”) that collect radio-based meter readings within a particular geographic area. The meter readings received from the endpoint devices 102-106 may be processed and forwarded by a CCU to a data processing system 110. In some embodiments, the collection system 108 may include a drive-by reading system or a mobile reading system (e.g., a system employing field vehicles and portable reader devices) that collects meter readings while a field vehicle is driving through a particular geographic area. Those skilled in the art and others will recognize that the collection of meter readings may be performed utilizing other meter reading systems (e.g., mesh/micro networks, handheld devices, Telephone-Base, etc.) and the examples provided herein should be construed as exemplary.

In one aspect, the collection system 108 is configured to leverage the two-way communication capabilities of the endpoint devices 102-106 when meter readings are collected from the endpoint devices. As will be discussed in further detail below, the endpoint devices 102-106 may be configured to record meter readings at particular intervals, calculate the current consumption data based on a correct set of intervals, and transmit the calculated consumption data in response to a request from the collection system. In one aspect, the endpoint devices record meter readings in such a way that any calculations on the fly performed by the collection system can be minimized and the communication between the collection system and the endpoint device can be reduced while an accuracy of less than an hour for consumption data can be maintained.

The discussion provided above with reference to FIG. 1 is intended as a brief, general description of one meter reading system 100 capable of implementing various features of the disclosed subject matter. While the description above is made with reference to particular devices linked together through different interfaces, those skilled in the art will appreciate that the claimed subject matter may be implemented in other contexts.

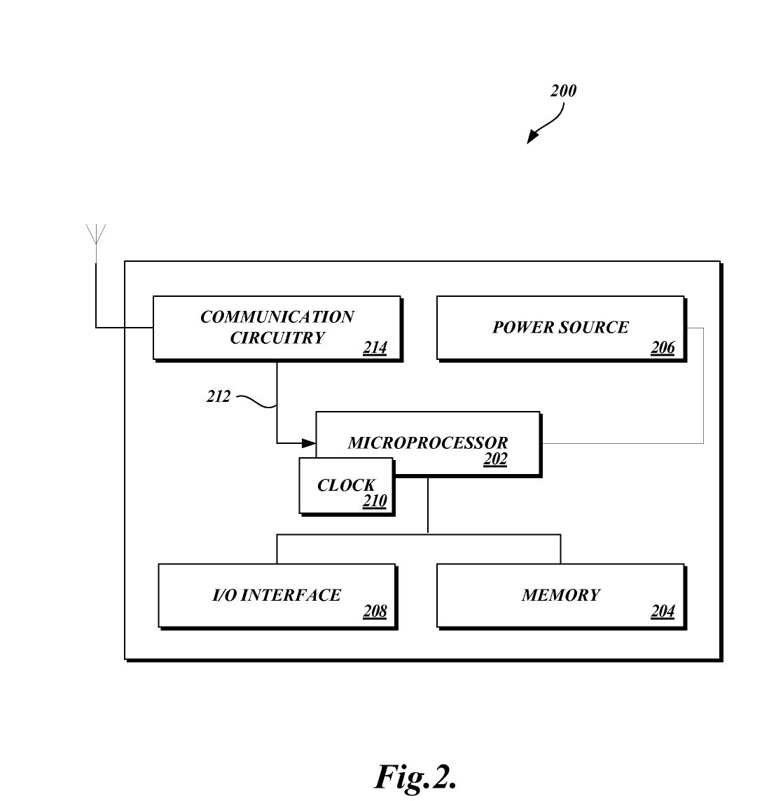

Now with reference to FIG. 2, an example component architecture for the endpoint device 200 will be described. Generally described, the endpoint device 200 includes a processor 202, a timing device or clock 210, and a memory 204, connected by a communication bus 212. As further depicted in FIG. 2, the endpoint device 200 includes an interface component 208 operable for communication with a corresponding utility meter (not shown) and a power source component 206, such as a battery or the like. The endpoint device 200 may further include communication circuitry 214 for transmitting/receiving wireless communications with other radio-based devices (e.g., collection systems, etc.) or a network.

In one aspect, the processor 202 is a microprocessor operable to perform timing and recording operations in connection with the timing device or clock 210 (e.g., a microcontroller-implemented timing clock, a radio timing clock, etc.). In one embodiment, the clock 210 is a slow crystal oscillator incremented by 2 seconds, which is configured to count every 60 minutes (an hour) and triggers recording of meter reading data at hourly intervals (or, alternatively, particular intervals set by the meter reading system). As such, the clock 210 tracks minutes but may not track hours and thus contains the minute portion of a current date/time. For example, if the current time is 6:25 PM, Jun. 1, 2008, the clock reads 25 minutes which is the minute portion of the current time.

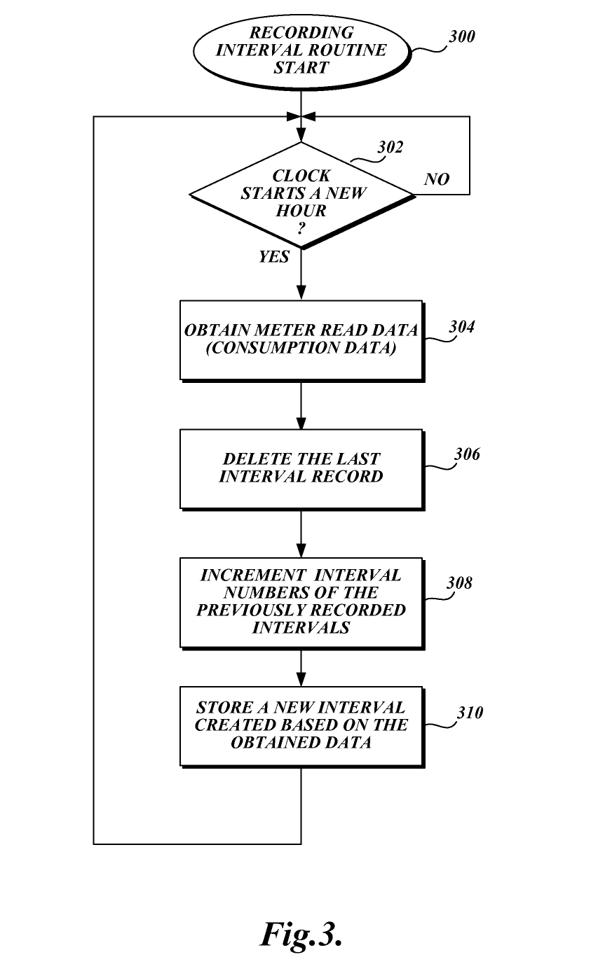

In some embodiments, the endpoint device contains in memory 204 a log of “recorded intervals” (meter reading data collected for the last 40 days at hourly intervals), a “partial hour interval” (meter reading data collected at an interval that is less than an hour), the “total consumption,” and the like. As used herein, the term, “interval” or “recorded interval,” refers to meter reading data collected during a particular hour, which is associated with an interval number that generally indicates a number of hours passed from the current time. As discussed above, the clock of the endpoint device counts every 60 minutes and triggers recording of a “recorded interval” for that hour. The recording process will be discussed in further detail below in connection with FIG. 3.

In some embodiments, the endpoint device keeps a log of 960 recorded intervals (i.e., a log of the last 40 days of hourly intervals) in the memory 204. As will be understood by one skilled in the art, the number of maximum recorded intervals, the number of days, the length of a time interval, or the like is rather a design choice. Thus, the aforementioned embodiments should not be considered as limiting the scope of the claimed subject matter. As will be well understood, keeping many days of intervals in the endpoint device is very useful. For example, the log of the days of intervals may be used to calculate the correct consumption for any time period. If there is an interruption (power failure) in communication or in the system (missing data because of the interruption), the data can be recovered from the log of recorded intervals as long as the collection system knows what time and how long. Since the logging/recording process will be discussed in further detail in connection with FIG. 3, the logging/recording process will only be briefly discussed here.

By way of example, an exemplary table showing recorded intervals (including the last interval for “12:00 PM-1:00 PM, Apr. 22, 2008”), a partial hour interval, and total consumption stored in the endpoint device at one point of the time is as follows:

TABLE 1

| Consumption | 123450 | 12:05 PM June 1^{st} 2008 |
|---|---|---|
| Partial hour | 3 | 12:00 PM-12:05 PM June 1st 2008 |
| Interval # | Value | |
| 1 | 12 | 11:00 AM-12:00 PM June 1st 2008 |
| 2 | 3 | 10:00 AM-11:00 AM June 1st 2008 |
| 3 | 2 | 9:00 AM-10:00 AM June 1st 2008 |
| 4 | 5 | 8:00 AM-9:00 AM June 1st 2008 |
| . | . | |
| . | . | |
| . | . | |
| 960 | 2 | 12:00 PM-1:00 PM April 22nd 2008 |

Generally described, to obtain the consumption data that have been collected during a certain time period, the collection system may send a request message that asks the endpoint device to go back a certain number of hours. In one aspect, the collection system can readily determine the last interval hour based on the current time kept by the end device (since the endpoint device keeps 960 intervals at any time) and request consumption data accordingly. In this regard, the collection system can request consumption of any time from the last interval. As shown above, the last (e.g., 960^{th} hour) interval is “12:00 PM-1:00 PM, Apr. 22, 2008” which can be determined from the current time, 12:05 PM Jun. 1, 2008. The first recorded interval for “11:00 AM-12:00 PM Jun. 1, 2008” is the most recent record in the log. In one aspect, the endpoint device is configured to record the intervals without any interruption or gaps in the intervals.

For ease of discussion, consider a scenario where, at 12:05 PM Jun. 1, 2008, the collection system requests from the endpoint device the consumption data of 9:00 AM Jun. 1, 2008 (i.e., consumption data that have been collected from the last interval to 9:00 AM Jun. 1, 2008). In this regard, the collection system may request the endpoint device to go back to 3 intervals to get the consumption data in question. In response to the request, the endpoint device obtains the current consumption, a partial hour interval and the last three intervals (for 3 hours), and subtracts the amount consumed between the current time (12:05 PM Jun. 1, 2008) and the requested time (9 AM Jun. 1, 2008) from the total consumption. Based on the table above, the amount consumed between the current time and the requested time is “20” since 3 (partial)+12 (first interval)+3 (second interval)+2 (third interval)=20. The endpoint device returns the requested consumption data (123450−20=123430), the consumption data of 9:00 AM Jun. 1, 2008, to the collection system. It should be well understood that the above table and the aforementioned scenarios are provided as examples and should not be construed as limiting the claimed subject matter.

Now referring to FIG. 3, a flow diagram of a recording interval routine 300 for logging and managing meter reading data at hourly intervals is illustrated in accordance with one embodiment of the disclosed subject matter. The recording interval routine 300 begins with block 302 where a determination is made as to whether the clock of the endpoint device starts a new hour. As mentioned above, the clock of the endpoint device tracks minutes of an hour and, at the start of a new hour, triggers hourly interval recording of meter reading data. In this regard, at the start of each new hour, meter reading data is read from the meter for recording a new recorded interval. The new recorded interval is stored in the memory of the endpoint device. If it is determined that the new hour has not started at decision block 302, the routine returns to decision block 302.

If it is determined at decision block 302 that the clock starts a new hour (i.e., after each 60 minutes), a meter reading data is obtained from the associated utility meter for generating a new recorded interval for the previous hour as illustrated in block 304. For example, at 2:00 PM, the endpoint device generates a new recorded interval for 1:00 PM-2:00 PM. At block 306, the last recorded interval in the log is deleted from the memory to maintain a fixed number of recorded intervals at any time. As discussed above, the endpoint device maintains a predetermined number of recorded intervals, for example, 960 recorded intervals. Thus, before adding a new recorded interval, the last recorded interval is removed from the memory. At block 308, the order of the existing recorded intervals that were previously stored is updated so that the new recorded interval is stored as the first recorded interval. In one embodiment, each recorded interval has an associated interval number, as shown in the above-mentioned tables. In that embodiment, the interval numbers of the existing recorded intervals are incremented. An example of the recorded intervals and the interval numbers are shown in the table discussed above. At block 310, a new recorded interval (with interval #1) created for the meter reading data at the start of a new hour is stored in the memory of the endpoint device. The routine 300 returns to block 302 where the routine repeats the above-mentioned steps.

It should be well understood that recording interval routine 300 described above with reference to FIG. 3 does not show all of the steps and functions performed within the endpoint device or the meter reading system. Although the recording interval routine 300 generally describes the logging and managing process that is triggered hourly by the clock, the logging and managing process can be triggered at particular intervals set by the meter reading system. Those skilled in the art and others will recognize that some steps and/or exchanges of data described above may be performed in a different order, omitted/added, or otherwise varied without departing from the scope of the claimed subject matter.

In the aforementioned embodiments, measurement accuracy of one hour can be warranted even within un-calibrated systems (where the endpoint device time has never been synchronized to an external clock). Some embodiments require more accurate timestamps for logging since an accuracy of one hour may be unacceptable and/or undesirable in many meter reading systems. As discussed previously, the endpoint device has a clock which tracks minutes and triggers recording of meter reading data for a particular hour at the end of that hour (or the start of a new hour after passing that particular hour). In one embodiment, to conserve battery power, a low power clock, such as a slow crystal oscillator, may be utilized by the endpoint device, which can drift 15-20 seconds per day, or 10-15 minutes in a 40 day period. Due to the time drift and the recording of meter reading data at hourly intervals, if this clock is not synchronized (not calibrated) to an external clock, the point where the endpoint device records data can be up to one hour off (an accuracy of one hour) in a worst case scenario. Such error can be eliminated, as will be described in more detail below, by adjusting the time of the clock of the endpoint device to the collection system time. After the endpoint device adjusts its clock to match the collection system time, the end of the hour of the clock actually corresponds to the end of the hour of the collection system time.

In some embodiments, when the endpoint device detects a triggering event for recording of a meter reading subsequent to the adjustment, the endpoint device stores a corresponding recorded interval along with an indication of the time adjustment. In one embodiment, a triggering event may be detected when the endpoint time starts a new time interval (e.g., the endpoint time crosses the top of an hour when hourly intervals are used). Upon detection of the triggering event, the endpoint device performs the interval recording process in accordance with the adjusted time.

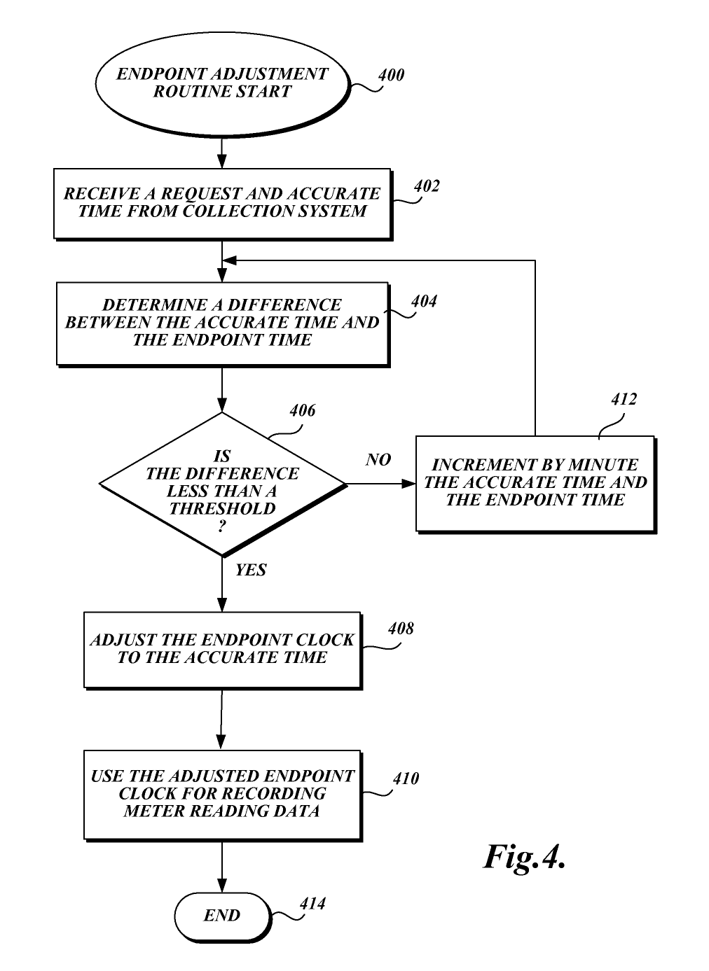

A representative embodiment of a process for adjusting the clock of the endpoint device is described in detail below in connection with FIG. 4. In one aspect, the process for adjusting the time clock of the endpoint device is performed in such a way that such adjustment does not create substantially short/long intervals, nor involve updating the existing recorded intervals stored in the endpoint device. In this regard, the process for adjusting the clock is based on the endpoint delaying the implementation of the time change (up to ½ hour) to eliminate the possibility of small intervals or long intervals. In one aspect, whenever time is adjusted, a flag is set to indicate the recorded interval was shorter/longer than an hour.

By way of example, consider a scenario where the collection system time is 58 minutes into the hour, for example, 2:58 PM Jun. 1, 2008 and the endpoint device time is 2 minutes into (or past) the hour of 3:00 PM Jun. 1, 2008. Upon receipt of the collection system time, the endpoint device reads the minute portion of the collection system time, which is 58 minutes. As discussed above, the collection system time is transferred in a real time format. In that scenario, simply adjusting the clock (the endpoint device) by moving the time forward will create a short interval (2 minute interval), which is not desirable. In this regard, the endpoint device may be configured to delay adjusting the time until the reader minutes roll over the hour. Subsequently, the time difference becomes 4 minutes since the endpoint device time is 4 minutes and the minute portion of the collection system time is 0 minutes (i.e., the collection system time is 3:00 PM). The endpoint device adjusts the time by moving its time back (by 4 minutes).

As discussed above, after the adjustment, the endpoint device records meter readings in accordance with the adjusted time. The endpoint device may store information about the time adjustment so that, when a meter reading is recorded subsequent to the time adjustment, the endpoint device can include the indication of time adjustment in that recording. In the above mentioned scenario, when the endpoint device time, subsequent to the adjustment, crosses the top of that hour (i.e., when the endpoint time starts a new hour, 4:00 PM Jun. 1, 2008), the endpoint device records the meter reading data in an hour and 4 minutes interval. That is, due to the adjustment, one recorded interval has 4 minutes more accumulated data. That interval is flagged to indicate the endpoint device time has been adjusted.

By way of another example, consider a scenario where the endpoint device time reads 58 minutes and the new collection system time is 2 minutes into an hour, for example, 3:02 PM Jun. 1, 2008. In that scenario, simply adjusting the clock (endpoint device) by moving the time back would cause an excessively long interval. In this regard, the endpoint device may be configured to delay adjusting the time, and keep both the endpoint device and collection system time, until the endpoint device time rolls over a new hour. Since a triggering event for recording is detected (while the endpoint device is delaying the time adjustment), the endpoint device records a meter reading for 2:00 PM-3:00 PM Jul. 1, 2009. In addition, the endpoint device also detects that the time difference becomes 4 minutes. The endpoint device adjusts its clock by moving its time forward by 4 minutes. In this scenario, when the endpoint device time, subsequent to the adjustment, crosses the top of that hour (i.e., when the endpoint time starts a new hour, 4:00 PM Jun. 1, 2008), the endpoint device records the meter reading data in a 56 minute interval. That is, due to the adjustment, the recorded interval has 4 minutes less accumulated data. That interval is flagged to indicate the endpoint device time has been adjusted.

As was described above, this approach and method of adjusting the endpoint device time can guarantee the shortest interval through the adjustment is limited to ½ hour, and the longest is limited to 1½ hour. In one aspect, there will be no additional cost or effort required for updating the existing recorded intervals since no adjustment needs to be made to the previously saved/logged recorded intervals due to the time adjustment. In one embodiment, the updated time of the endpoint device is returned to the collection system.

Now referring to FIG. 4, a flow diagram of an endpoint adjustment process routine 400 for adjusting the endpoint device time is illustrated in accordance with one embodiment of the claimed subject matter.

The endpoint adjustment process routine 400 begins with block 402 where an endpoint device receives an accurate time from a collection system. As discussed above, the collection system may send a request (e.g., a message) for consumption data of a specific time and the collection system time for adjusting the end device time. The clock of the endpoint device may or may not contain the same number of minutes in the current hour. Upon receipt of the collection system time, the endpoint device reads the minute portion of the collection system time and keeps the collection system time in the memory.

At block 404, the difference between the received collection system time and the time of the clock (the endpoint device time) is determined. At decision block 406, a determination is made as to whether the difference is less than a threshold, for example 30 minutes. In one aspect, if the determined difference is less than the threshold, a time adjustment will be made, forward or backwards, without delaying the adjustment. If the determined difference is not less than the threshold, the time adjustment is delayed until the determined difference becomes less than the threshold.

If it is determined that the difference is not less than the threshold at decision block 406, the collection system time is incremented as is the time of the clock at block 412. In one embodiment, the endpoint device keeps track of both the collection system time and the endpoint device time during the adjustment delay. It is noted that, during the adjustment delay, the clock continues to be used to update interval recordings as described in FIG. 3. The routine repeats the above-mentioned steps until the determined difference becomes less than the threshold (e.g., 30 minutes).

If it is determined that the difference is less than the threshold at decision block 406, the clock of the endpoint device is adjusted to the collection system time by moving the endpoint device time back or forward at block 408. The endpoint device may store information about the time adjustment so that, when a meter reading is recorded subsequent to the time adjustment, the endpoint device can include the indication of time adjustment in that recording. In one embodiment, the endpoint device uses a field (e.g., a 15 bit field, etc.) to record the hourly intervals and another field (e.g., one bit field, etc.) to indicate whether the time has been adjusted in that interval. It may be important for the collection system to be aware of this in recalculating past data from interval data.

At block 410, the adjusted clock of the endpoint device is used to perform the interval recording process as described in FIG. 3 and to communicate with the collection system. As discussed above, if the endpoint clock finishes a time interval (e.g., a current hour, a current interval, etc.) after the adjustment, a recorded interval is stored to contain meter reading data accumulated for the time interval along with an indication of the time adjustment, such as a flag or the like. Subsequently, the endpoint device performs a logging and recording process according to the adjusted endpoint time. In this manner, there is one time interval which becomes a bit longer or shorter than a regular time interval. That time interval is flagged to indicate the time adjustment. As such, in some embodiments using hourly intervals for recording, it is guaranteed that the shortest time interval through the adjustment is limited to ½ hour, and the longest time interval is limited to 1½ hour. The routine 400 terminates at block 414.

It should be well understood that endpoint adjustment process routine 400 described above with reference to FIG. 4 does not show all of the functions and steps performed within the collection system. Instead, the endpoint adjustment process routine 400 generally describes the process performed to adjust the clock of the endpoint device and to record a current interval in accordance with the adjustment in order to properly calculate consumption data in response to a request from the collection system. Those skilled in the art and others will recognize that some functions/steps and/or exchange of data described above may be performed in a different order, omitted/added, or otherwise varied without departing from the scope of the claimed subject matter.

While illustrative embodiments have been illustrated and described, it will be appreciated that various changes can be made therein without departing from the spirit and scope of the claimed subject matter.

The embodiments of the invention in which an exclusive property or privilege is claimed are defined as follows:

1. A method for adjusting time of a device wherein the device is configured to obtain meter reading data from a corresponding meter, and to transfer the obtained meter reading data to a collection system, the method comprising:
receiving a current reader time from the collection system;
determining a difference between the current reader time and a device time of the device;
if the difference is not less than a threshold for adjusting time, delaying adjustment of the device time until the difference becomes less than the threshold;
if the difference is less than the threshold:
adjusting the device time to the current reader time;
after adjustment of the device time:
detecting a triggering event for recording meter reading data; and
upon detection, recording meter reading data along with an indication of the adjustment of the device time.

2. The method of claim 1, wherein the triggering event is detected when the device time starts a new time interval.

3. The method of claim 1, wherein the meter reading data is obtained at each time interval.

4. The method of claim 3, wherein the meter reading data obtained at a time interval are recorded to generate a recorded interval and
the time interval information and the generated record interval are stored in the device, wherein a fixed number of recorded intervals are maintained in the device.

5. The method of claim 4, wherein an interval number is assigned with each recorded interval.

6. The method of claim 5, wherein the time interval is an hourly time interval.

7. The method of claim 6, wherein the interval number indicates the number of hours passed from the time when the meter reading data contained in the recorded interval is collected.

8. The method of claim 6, wherein the triggering event is detected when the device time crosses the top of an hour.

9. The method of claim 1, wherein delaying adjustment of the device time includes incrementing the current reader time and the clock of the device.

10. The method of claim 8, wherein delaying adjustment of the device time further includes determining the difference between the current reader time and a device time as the current reader time is incremented.

11. The method of claim 1, wherein the threshold for adjusting time is 30 minutes.

12. An apparatus for transferring accurate meter reading data to a collection system, the apparatus operable to:
receive a reader time from the collection system;
determine a difference between the reader time and a device time of the clock;
delay a device time adjustment as long as the difference is as great as a threshold for adjusting the device time;
if the difference is less than the threshold, adjust the clock to the reader time; and
after the clock is adjusted:
detect a triggering event for recording meter reading data; and
upon detection, record meter reading data along with an indication of the device time adjustment.

13. The apparatus of claim 12, wherein the meter reading data is obtained at each time interval.

14. The apparatus of claim 13, wherein the meter reading data obtained at a time interval are recorded to generate a recorded interval and
the time interval information and the generated record interval are stored in the device, wherein a fixed number of recorded intervals are maintained.

15. The apparatus of claim 14, wherein while the device time adjustment is delayed, the reader time is incremented as is the clock.

16. The apparatus of claim 14, wherein the clock provides a device time that is represented in minutes of an hour.

17. The apparatus of claim 16, wherein the minute portion of the reader time is extracted to determine the difference between the reader time and the device time.

18. A computer-readable medium having computer-executable components for adjusting a device time to calculate accurate meter reading data, the computer-executable components comprising:
a recording component for:
storing a set of recorded intervals, wherein a recorded interval is generated to include the meter reading data collected at a time interval and
maintaining a fixed number of recorded intervals;
a calculation component for calculating the consumption of a utility service over a specified number of time intervals;
an adjustment component operative to:
determine a difference between the current reader time and the device time of an endpoint device;
delay adjustment of the device time until the difference is less than a threshold; and
if the difference is less than the threshold:
adjust the device time to the current reader time;
detect a start of a time interval in accordance with the adjusted device time; and
upon detection, record meter reading data along with an indication of the adjustment of the device time.

19. The computer-readable medium as recited in claim 18, wherein each recorded interval is generated to include the meter reading data collected at each hour and information of the hour.

20. The computer-readable medium as recited in claim 18, wherein the adjustment component is configured to increment the current reader time according to a clock of the endpoint device while delaying the device time adjustment.
